(19) United States
(12) Patent Application Publication
(10) Pub. No.: US 2021/0114134 A1
(43) Pub. Date: Apr. 22, 2021

(54) Seam welder conductive mechanism

(71) Applicants: Hong Kang, San Marino, CA (US); David Kang, San Marino, CA (US)

(72) Inventors: Hong Kang, San Marino, CA (US); David Kang, San Marino, CA (US)

(21) Appl. No.: 16/658,010

(22) Filed: Oct. 18, 2019

(51) Int. Cl. B23K 11/30

(52) U.S. Cl. CPC B23K 11/3045

(57) ABSTRACT

The seam welder conductive mechanism is the main part of the resistance seam welding machine. When the electrode wheel rolling on the welded parts, the Seam welder conductive mechanism will withstand the high press of electrode force and pass the high welding current from welding transformer to the electrode wheels of seam welding machine. Because of these two characteristics the following factors must be considered during the design of seam welder conductive mechanism. First of all, in order to withstand the high press of electrode force two bearings are introduced in the mechanism, the bearing should be lubricated and also isolated from the welding current in order to get long working time without damaging the bearing. Second of all, in order to pass the high welding current, the conductive pair with relative motion must be keep conduction all the time with certain surface pressure and lubrication, the conductive pair without relative motion must be keep conduction all the time with big surface pressure. Because of the high current pass through the conductive mechanism must be cooled with water during working. This is a mechanism equipped with water cooling for Electrode, main shaft, and Silver-plate conductive pads.

### BACKGROUND OF THE INVENTION

The Seam welder conductive mechanism has only one moving the cylindrical conductive surface, and also soft copper strip system lets the high current passing by with less contact resistance. This makes the Seam welder conductive mechanism has a long life span and easy manufacturing and maintaining.

### BRIEF SUMMARY OF THE INVENTION

The high press electrode force is withstanding by the electrode, main shaft and two bearings.
Silver plate conductive pads and main shaft is lubricated by special grease.
All the parts that welding current passing by is water cooled.
Two shaft system keeping the Silver plate conductive pads in the right position.
Soft copper strip system let the high current passing by with less contact resistance.
This Seam welder conductive mechanism is easy manufacturing and maintaining.
This Seam welder conductive mechanism has long life span.

### BRIEF DESCRIPTION OF THE SEVERAL VIEWS OF THE DRAWINGS

FIG. 1 is front view of the Seam welder conductive mechanism.

FIG. 2 is side view of the Seam welder conductive mechanism.

FIG. 3 is front view of the parts that the high welding current is passing through.

FIG. 4 is side view of the parts that the high welding current is passing through.

### DETAILED DESCRIPTION OF THE INVENTION

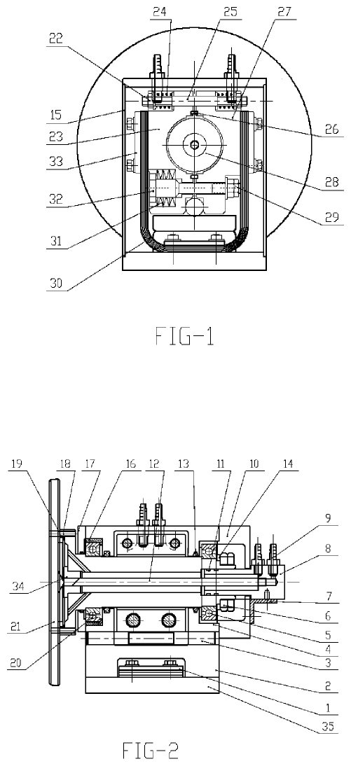

Seam welder conductive mechanism is assembled from following parts FIG. 1 and FIG. 2:

Part number 1. Press platen: keep 30 Conductive soft copper strip and 35 Conductive plate copper plate contact firmly together with the screw bolts.

Part number 2. Bearing box: Through 20 bearings support 28 Main shaft,

Part number 3. Small Shaft axis: Keep 23 Silver plate conductive pad 1 and 27 Silver plate conductive pad 2 not rotating on the 28 Main shaft.

Part number 4. Rear insulated bearing sleeve: Keep the bearing out of the welding current passing by.

Part number 5. Bearing: Support 28 Main shaft

Part number 6. Round nut: Keep 28 Main shaft on the 5 Bearing

Part number 7. Fixed block: Keep 8 Plugging on 28 Main shaft.

Part number 8. Plugging: cooling water in and out with 9 Water connector.

Part number 9. Water connector: cooling water in and out.

Part number 10. Cap: Holding the 8 Plugging.

Part number 11. O-ring seal: sealing the cooling water.

Part number 12. Water guide tube: Guide the cooling water to electrode

Part number 13. Resistance dust ring: Ensure that the bearing lubricant does not leak.

Part number 14. Spacer: Prevent 6 Round nut from loosening.

Part number 15. Plate: Prevent water and dust go in to the 2 bearing box

Part number 16. Front insulated bearing sleeve: Keep the bearing out of the welding current passing by.

Part number 17. End cap: Prevent water and dust go in to the 2 bearing box

Part number 18. Socket head cap screws: Keep 21 Electrode to contact to 28 main shaft firmly.

Part number 19. O-ring seal: keep the cooling water in the 28 main shaft.

Part number 20. Bearings: Support 28 Main shaft

Part number 21. Electrode: to contact the welded parts and welding.

Part number 22. Nuts: adjusting the force of spring

Part number 23. Silver plate conductive pad 1: Welding current passing by with silver conductive pat tach to main shift.

Part number 24. Spring: Keep 23 Silver plate conductive pad 1 and 27 Silver plate conductive pad 2 firmly contact to 28 Main shaft all the time.

Part number 25. bolts: hold the two 24 Spring

Part number 26. sealing strip: Keep the grace in the conductive area.

Part number 27. Silver plate conductive pad 2: Welding current passing by with silver conductive pat tach to main shift.

Part number 28. main shaft: Support the 21 electrode and Welding current passing by

Part number 29. nuts: adjusting the force of 31 disc spring

Part number 30. conductive soft copper strip: Welding current passing by

Part number 31. disc spring: Keep 23 Silver plate conductive pad 1 and 27 Silver plate conductive pad 2 firmly contact to 28 Main shaft all the time.

Part number 32. bolt: hold the 31 disc Spring

Part number 33. pressure plate: keep 30 Conductive soft copper strip and 23 Silver plate conductive pad 1 and 27 Silver plate conductive pad 2 firmly together with the screw bolts.

Part number 34. spacer: Keep 12 Water guide tube at central position.

Part number 35. conductive plate copper plate: Welding current passing by

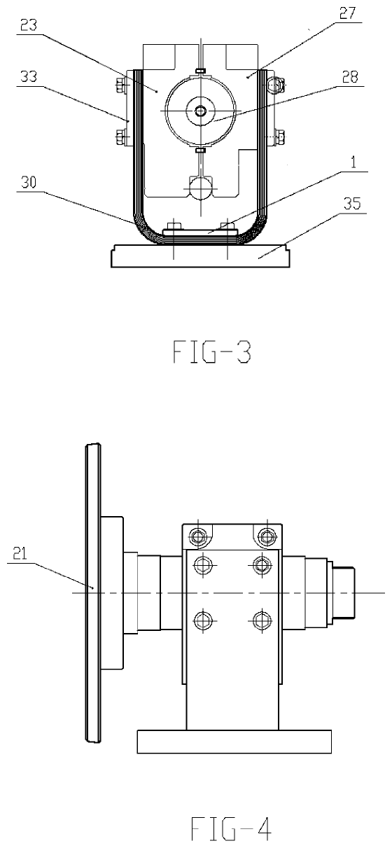

The Seam welder conductive mechanism characteristics are following:
The high press electrode force is withstanding by the electrode 21, main shaft 28 and two bearing parts number 5.
FIG. 3 and FIG. 4, The high welding current is passing through parts number 35 to 30, 23, 27, 28, and to 21 electrodes. Parts 35 to 30, 23, 27 are connected by soft copper strip can be passing more current. Part 27 and 23 contact to part 28 is silver plate conductive pad system let the high current passing through when the electrode rolling. FIG. 1 The silver plate conductive pad 23 and 27 is pressed by Disc springs parts 31 contact to main shaft 28.
Silver plate conductive pad 2 and 1 and main shaft is lubricated by special grease.
All the parts that welding current passing by is water cooled.
Two shaft system keeping the Silver plate conductive pad 2 and 1 in the right position.
Soft copper strip system let the high current passing by with less contact resistance.
This Seam welder conductive mechanism is easy manufacturing and maintaining.
This Seam welder conductive mechanism has long life span.

The inventions claimed are:

1. The high welding current is passing through a conductive plate copper plate to conductive soft copper strip, Silver-plate conductive pads, main shaft, and to the electrode.

2. Conductive plate copper plate, Silver plate conductive pads are connected by a conductive soft copper strip which can be passing high welding current with less contact resistance.

3. Silver-plate conductive pads contact to the main shaft is a silver plate conductive pad system lets the high current passing through when the electrode rolling.

4. The silver plate conductive pads are pressed by Disc springs contact to the main shaft. After the conductive pair is worn, the conductive surface can still be ensured to be in good contact, and large welding current can be passed.

5. Two shaft system keeping the Silver-plate conductive pads in the right position and without relative rotation with the main shaft during the welding.

6. Soft copper strip system let the high current passing by with less contact resistance. This makes the seam welder conductive mechanism has a long-life span.

7. All the parts that welding current passing by is water-cooled. The Electrode is water-cooled with a large round area with a special designed main shaft flange.

8. The Seam welder conductive mechanism has only one moving the cylindrical conductive surface, it is easy for manufacturing and maintaining.
